(19) United States
(12) Patent Application Publication
(10) Pub. No.: US 2025/0316923 A1
(43) Pub. Date: Oct. 9, 2025

(54) ANTI-MISPLUG SAFETY SOCKET

(71) Applicant: Zhejiang Yuchuang Electronic Technology Co., Ltd., Wenzhou (CN)

(72) Inventors: Yangen CHEN, Wenzhou (CN); Jingzheng CHEN, Wenzhou (CN)

(21) Appl. No.: 18/930,918

(22) Filed: Oct. 29, 2024

(30) Foreign Application Priority Data
Apr. 3, 2024 (CN) 2024103972776

(51) Int. Cl. H01R 13/453

(52) U.S. Cl. CPC H01R 13/453

(57) ABSTRACT

An anti-misplug safety socket is disclosed. The surface cover is provided with at least two jacks; the bottom shell is internally provided with a mounting frame for mounting a moving plate, two side plates of the mounting frame are provided with oblique sliding grooves obliquely distributed, the moving plate is provided with at least one through hole through which the plug rod passes, the moving plate is provided with an elastic reset mechanism, the elastic reset mechanism pushes the moving plate to be in an initial position, the moving plate shields the two jacks in an initial position state, two sides of the moving plate are provided with sliding blocks, the sliding blocks are plugged into the oblique sliding grooves, the sliding blocks are located at top ends of the oblique sliding grooves in an initial position state, the moving plate is provided with a blocking mechanism.

### CROSS-REFERENCE TO RELATED APPLICATIONS

The present application claims priority to Chinese Patent Application No. 2024103972776, filed Apr. 3, 2024, the entire disclosure of which is incorporated herein by reference.

### TECHNICAL FIELD

The present disclosure relates to the field of conductive safety sockets, and in particular to an anti-misplug structure of a safety socket.

### BACKGROUND

The utility model patent with publication number CN203039153U authorized on Jul. 13, 2013, entitled “safety socket” discloses a sliding plate type anti-misplug structure, which specifically includes a base, an upper cover, and conductive contact pieces arranged in the base and matching power plug pole pieces. Positions of the upper cover corresponding to the conductive contact pieces are provided with corresponding socket holes, and a safety gate device is arranged in the upper cover. The safety gate device includes a sliding block assembly consisting of two sliding plates and reset mechanisms corresponding to the sliding plates. Through holes through which the power plug pole pieces pass are provided on the two sliding plates, the sliding plates are each provided with an slope, the through holes of the sliding plates are configured as a sunken platform, the two slopes of the sliding plates are mutually embedded on the sunken platform of the two sliding plates, and the two sliding plates are each provided with a limiting structure limiting mutual separation of the two sliding plates. The two pole pieces of a plug simultaneously interact with the slopes of the two sliding plates to make the two sliding plates slide, and a slidable relative distance between the two sliding plates is greater than twice a thickness of the single plug pole piece. After the plug is unplugged from a socket, since a direction of a reset elastic force of each reset mechanism is opposite a sliding direction of the sliding plate making contact with the reset mechanism, the reset mechanism will push the two sliding plates to align the two slopes on the two sliding plates with the socket holes, and to make bottom surfaces of the two sliding plates opposite the slopes mutually close the through holes through which the power plug pole pieces on the sliding plates pass on the sliding plates. Although the safety socket solves the problem of misplug by means of the two sliding plates, the two sliding plates are used, resulting in a complex structure, frequent mutual interference, and easy failure. Furthermore, manufacturing cost is relatively high. With the travel limitation of a moving plate of the safety socket, more models of safety sockets, such as a 20-ampere safety socket, cannot be covered.

### SUMMARY

The technical problem to be solved by the present disclosure is to provide an anti-misplug safety socket. Sliding switching of a moving plate in an anti-misplug structure of the socket is more stable and efficient, and the anti-misplug structure is simpler as a whole.

To this end, an anti-misplug safety socket according to the present disclosure includes a bottom shell and a surface cover, where the surface cover is provided with at least two jacks, and the jacks are used for plugging plug rods to achieve conductive connection; the bottom shell is internally provided with a mounting frame for mounting a moving plate, two side plates of the mounting frame are provided with oblique sliding grooves obliquely distributed, the moving plate is arranged below the jacks, the moving plate is provided with at least one through hole through which the plug rod passes, the moving plate is provided with an elastic reset mechanism, the elastic reset mechanism pushes the moving plate to be in an initial position, the moving plate shields the two jacks in an initial position state, two sides of the moving plate are provided with sliding blocks, the sliding blocks are plugged into the oblique sliding grooves, the sliding blocks are located at top ends of the oblique sliding grooves in an initial position state, the moving plate is provided with a blocking mechanism, and when a single rod member is plugged into the jacks to push the moving plate, the pushed moving plate swings, such that the blocking mechanism achieves buckling, and the moving plate is prevented from moving by means of buckling; and the two plug rods of a plug synchronously push the moving plate when being simultaneously plugged into the two jacks, positions of the plug rods pushing against the moving plate are located at two sides of a connecting line of the two sliding blocks separately, the moving plate translates downwards along the oblique sliding grooves by taking the sliding blocks on two sides as fulcrums, and a channel for plugging is abdicated during translation of the moving plate, such that the plug continues to be plugged into the socket to achieve conductive plugging.

The present disclosure has the technical effects:

1. At two side ends of the moving plate in the present disclosure, the sliding blocks are plugged into the oblique sliding grooves of the two side plates of the mounting frame to achieve sliding fit, the two sliding blocks are located in the middle of the moving plate, the two plug rods of the socket simultaneously push against the moving plate when plugged, and pushed positions are located at two sides of a connecting line of the two sliding blocks separately; in this case, the two sides of the movable plate are uniformly stressed and pressed down, and the sliding blocks are constrained by the oblique sliding grooves to obliquely slide downwards in a pressing process, such that the through holes and a rear space of the moving plate are aligned with the jacks above, and the plug is plugged into the channel to achieve conduction; and because only one moving plate is used, the structure is relatively simple, and mounting is more convenient. Moreover, movement of the moving plate is constrained by cooperation of the sliding blocks and the oblique sliding grooves, and a whole movement process is more efficient and stable in combination with uninterrupted swing range protection limit of a gear upper slope on the front side of the clamping block and gear side slopes.

2. The moving plate is constrained by cooperation of the sliding blocks and the oblique sliding grooves, and is further protected by the gear upper slope on the front side of the clamping block and the gear side slopes on two sides of an abdication groove such that the situation that the moving plate overturns in a process of vertical translation, which is not conducive to translation can be prevented, and further, the translation after the socket is plugged is smoother.

3. A blocking sheet is fixedly arranged in the bottom shell of the socket, a plug sheet in the socket forms a conductive plug end, the blocking sheet extends into the mounting frame and is located above the conductive plug end at the jack on the front side, the blocking sheet shields part of a front side of the conductive plug end, and the plug rods of the socket enter the conductive plug end from a rear side of the blocking sheet when plugged such that accidental electric shock when a needle-like conductive rod is obliquely plugged forwards from the jack on the front side can be avoided.

### BRIEF DESCRIPTION OF THE DRAWINGS

In order to more clearly illustrate the technical solutions in the examples of the present disclosure or in the prior art, the accompanying drawings required for the description of the examples or the prior art will be briefly introduced below. Obviously, the accompanying drawings in the following description are some examples of the present disclosure. Those of ordinary skill in the art would further be able to derive other accompanying drawings from these accompanying drawings without making creative efforts.

In addition, in the accompanying drawings, the same components use the same reference numerals, and the accompanying drawings are not drawn to actual scale.

FIG. 1 is a schematic structural diagram of an anti-misplug safety socket according to the present disclosure.

FIG. 2 is a schematic structural sectional view of the anti-misplug safety socket in FIG. 1.

FIG. 3 is a schematic diagram of a three-dimensional structure of a moving plate and a mounting frame in FIG. 2.

FIG. 4 is a side view of a mounting frame in FIG. 3.

FIG. 5 is a schematic diagram of a three-dimensional structure of a moving plate.

FIG. 6 is a schematic structural diagram of a moving plate in FIG. 5 from a bottom perspective.

FIG. 7 is a schematic diagram of a three-dimensional structure of the mounting frame in FIG. 4.

FIG. 8 is a schematic diagram of a structural plane of a back surface of a surface cover.

FIG. 9 is a schematic structural diagram of an anti-misplug safety socket in which a surface cover is disassembled.

FIG. 10 is a schematic structural diagram of the anti-misplug safety socket in FIG. 9 after a moving plate and a mounting frame on one side are disassembled.

FIG. 11 is a schematic structural diagram of the anti-misplug safety socket in FIG. 1 after a single rod is plugged into a jack on a front side, where a moving plate is clamped.

FIG. 12 is a schematic structural diagram of the anti-misplug safety socket in FIG. 1 after two plug rods of a plug are plugged from two jacks respectively, where a moving plate translates downwards and forwards to abdicate a channel through which a plug passes.

### DETAILED DESCRIPTIONS OF THE EMBODIMENTS

In order to make the objectives, technical solutions and advantages of the examples of the present disclosure more clear, the technical solutions in the examples of the present disclosure will be clearly and completely described below in combination with the accompanying drawings in the examples of the present disclosure. Obviously, the examples described are some examples rather than all examples of the present disclosure. All other examples obtained by those of ordinary skill in the art on the basis of the examples in the present disclosure without making creative efforts shall fall within the scope of protection of the present disclosure.

So-called “front” and “rear” in the present disclosure refer to a right side shown in the accompanying drawings as front (which is specifically that one side having a blocking sheet is a front side) and a left side shown in the accompanying drawings as rear respectively. The right side is a direction in which a movable closing plate is pushed down by double plugs and then translated.

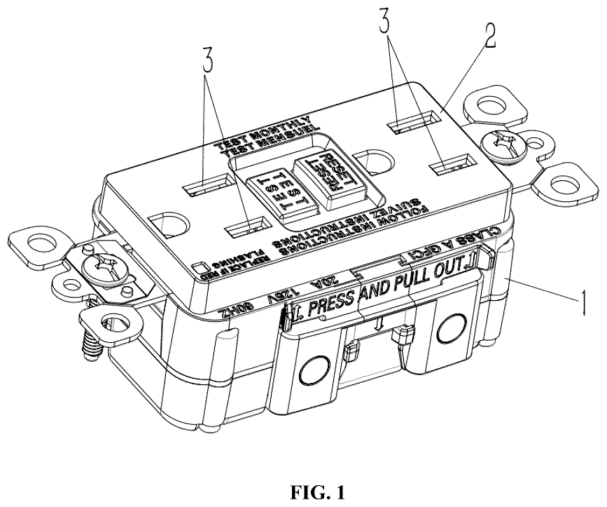

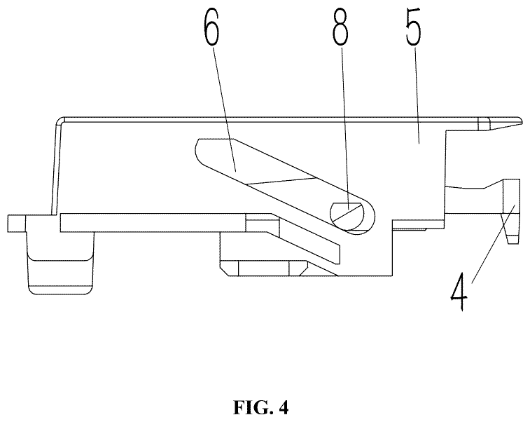

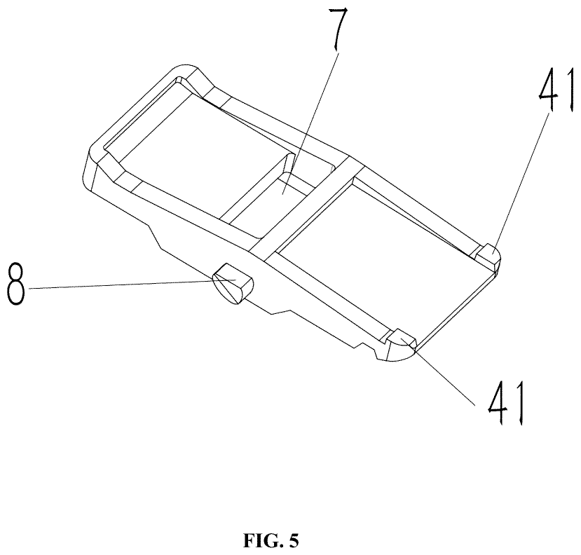

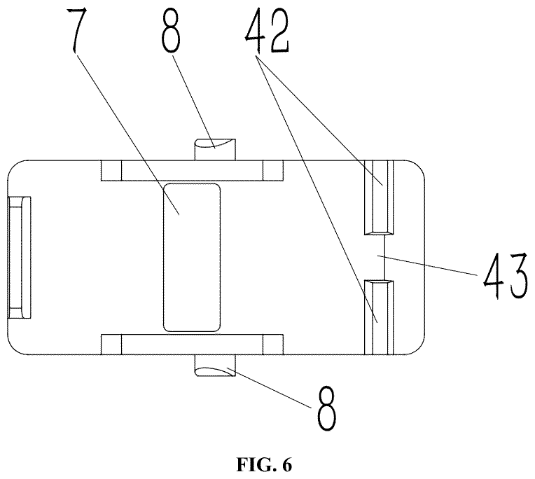

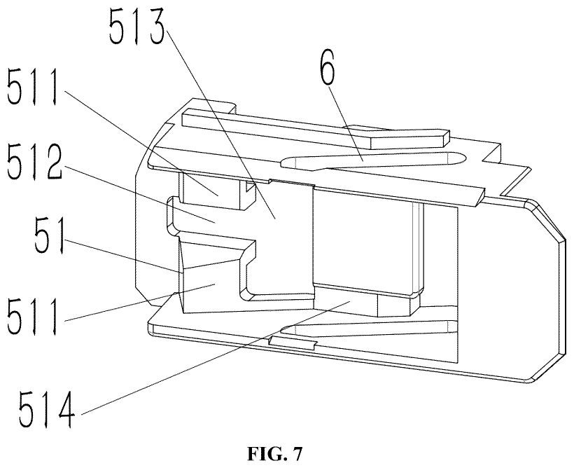

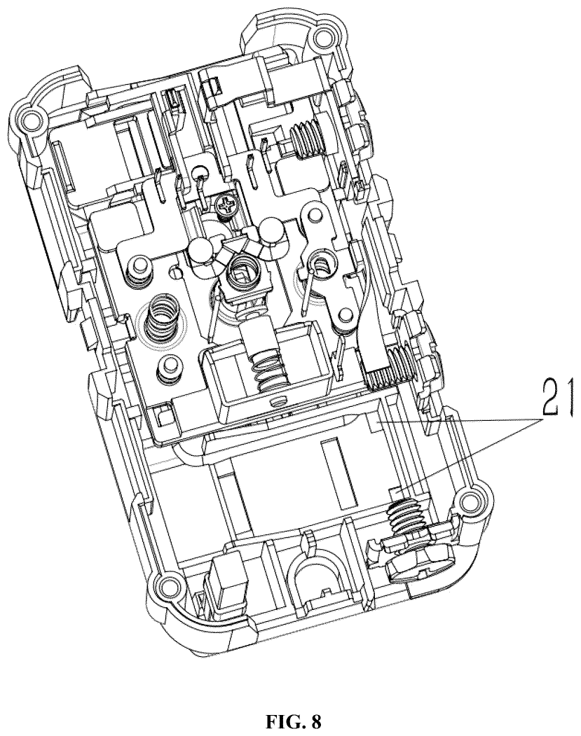

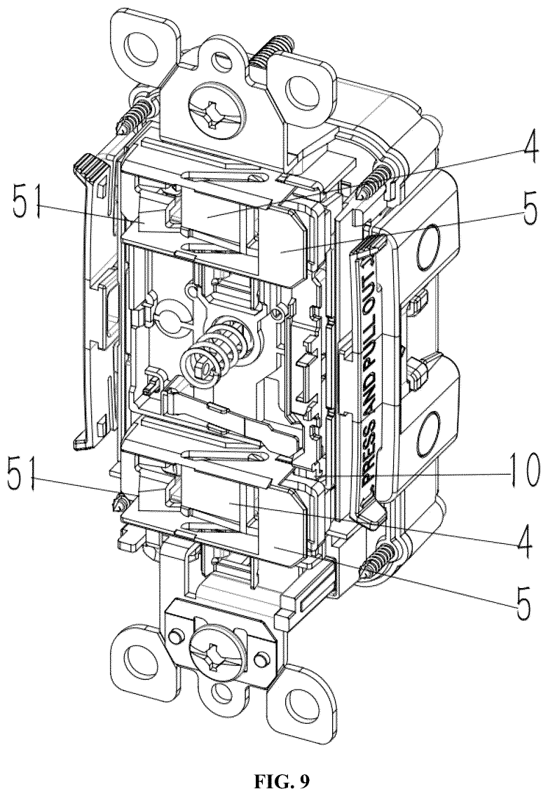

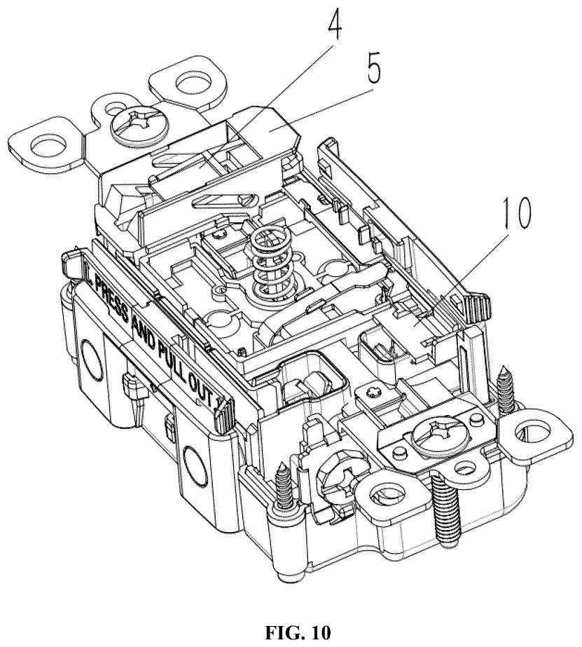

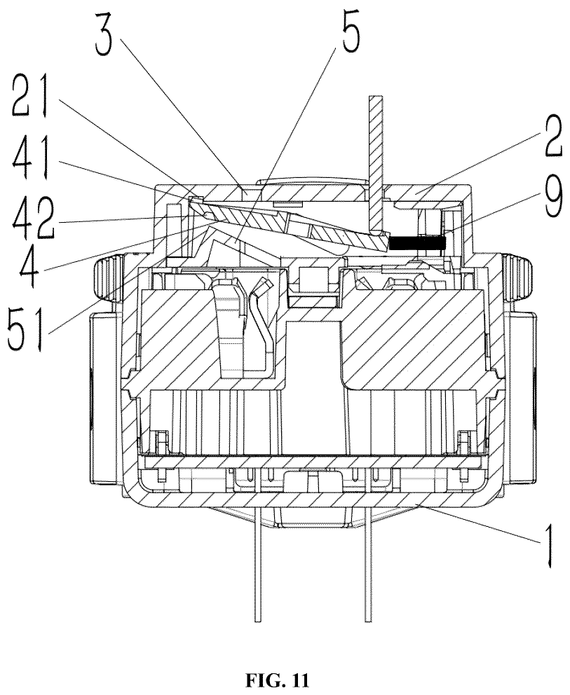

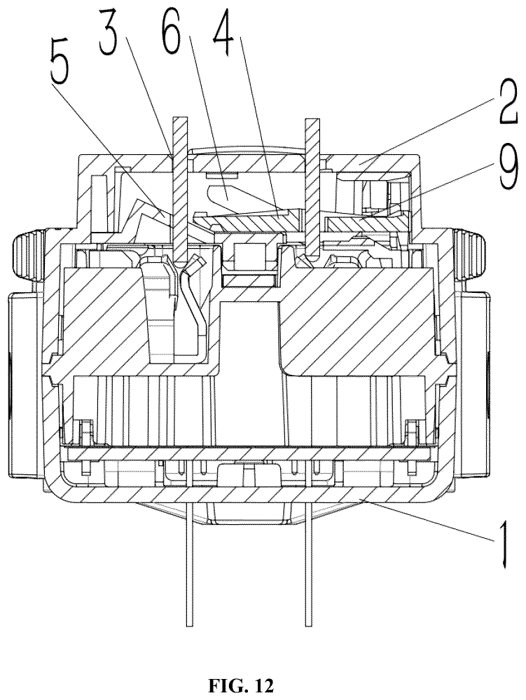

With reference to FIGS. 1-12, an anti-misplug safety socket according to Example 1 of the present disclosure includes a bottom shell 1 and a surface cover 2, where the surface cover 2 is provided with at least two jacks 3, the jacks 3 are used for plugging plug rods to achieve conducive connection, the bottom shell 1 is internally provided with a mounting frame 5 for mounting a moving plate 4, two side plates of the mounting frame 5 are provided with oblique sliding grooves 6 obliquely distributed, the moving plate 4 is arranged below the jacks 3, the moving plate 4 is provided with at least one through hole 7 through which the plug rods can pass, the moving plate 4 is provided with an elastic reset mechanism, the elastic reset mechanism pushes the moving plate 4 to be in an initial position, the moving plate 4 shields the two jacks 3 in an initial position state, two sides of the moving plate 4 are provided with sliding blocks 8, the sliding blocks 8 are plugged into the oblique sliding grooves 6, the sliding blocks 8 are located at top ends of the oblique sliding grooves 6 in the initial position state, the moving plate 4 is provided with a blocking mechanism, and when a single rod member is plugged into the jacks 3 and then pushes the moving plate 4, the pushed moving plate 4 swings, such that the blocking mechanism achieves buckling, and the moving plate 4 is prevented from moving by means of buckling. The two plug rods of a plug synchronously push the moving plate 4 when being simultaneously plugged into the two jacks, positions of the plug rods pushing against the moving plate 4 are located at two sides of a connecting line of the two sliding blocks 8 separately, the moving plate 4 translates downwards along the oblique sliding grooves 6 by taking the sliding blocks 8 on two sides as fulcrums, and a channel for plugging is abdicated during translation of the moving plate 4, such that the plug continues to be plugged into the socket to achieve conductive plugging. In the example, after the moving plate 4 translates downwards and forwards, the through hole 7 and a rear end of the moving plate 4 form front and rear channels into which the plug rods are plugged separately. In the example, the specific structure of the elastic reset mechanism is as follows: two sets of moving plates 4 and mounting frames 5 are arranged in the socket, a set of jacks 3 on the surface cover 2 is correspondingly arranged above each set of moving plates 4 and mounting frames 5, and the elastic reset mechanism includes a reed 9 arranged on a frame in the bottom shell 1, where two ends of the reed 9 are tilted to support front end plates of the moving plates 4 on two sides respectively, a middle of the reed 9 is in a straight strip shape, and two ends of the reed are titled towards the moving plate 4 to support the moving plate 4.

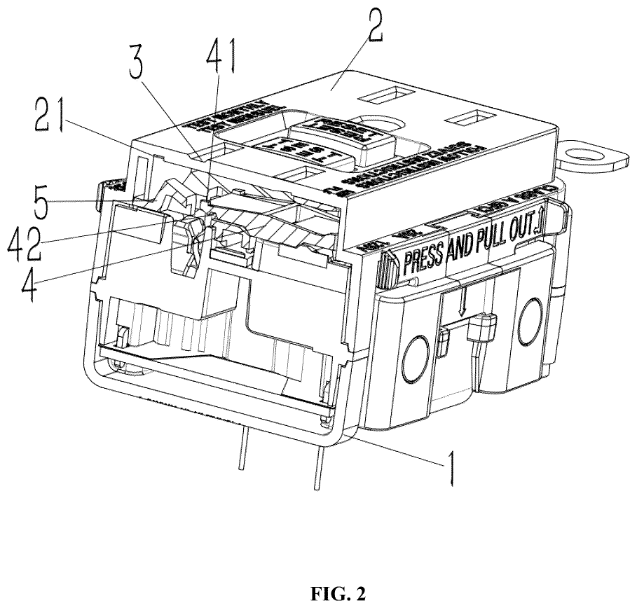

With reference to FIGS. 2-7, in order to urge the moving plate 4 to achieve clamping by means of the blocking mechanism and prevent the moving plate 4 from sliding obliquely downwards after the single rod is plugged to push the moving plate 4 to swing, the blocking mechanism of the example includes clamping bumps 41 arranged at two corners of an upper side of a rear end of the moving plate 4 and a clamping groove 42 provided at a lower side of the rear end of the moving plate, and further includes bump clamping grooves 21 provided at a lower side of the surface cover 2 corresponding to the clamping bumps 41 and a clamping block 51 arranged on the mounting frame 5 corresponding to the clamping groove 42 and matching the clamping groove 42, where an upper end of the clamping block 51 is provided with a clamping end capable of being clamped into the clamping groove 42. When the rod member is plugged into the jack 3 on a front side separately, the rear end of the moving plate 4 is titled upwards, such that the clamping bumps 41 on the moving plate 4 clamp the bump clamping grooves 21 on the lower side of the surface cover 2. When the rod member is plugged into the jack 3 on a rear side separately, the rear end of the moving plate 4 swings downwards, such that the clamping groove 42 on the moving plate 4 is clamped to the clamping block 51 for matching. In two cases, the moving plate 4 can be prevented from moving downwards, such that a blocking state for the rod member can be maintained, and the situation that the rod member is abdicated to the position of the channel and is plugged for conduction due to sliding of the moving plate is avoided. The blocking mechanism is arranged in various ways, and the innovation lies in a structure in which upper and lower portions are provided with clamping positions, which can achieve vertical swing for clamping. As for a specific clamping mechanism, a middle of the surface cover 2 is provided with a clamping groove, and a middle of a rear end of the moving plate 4 is correspondingly provided with a clamping block, or a rear end of the mounting frame 5 is provided with a groove, and a bump is arranged on the moving plate 4.

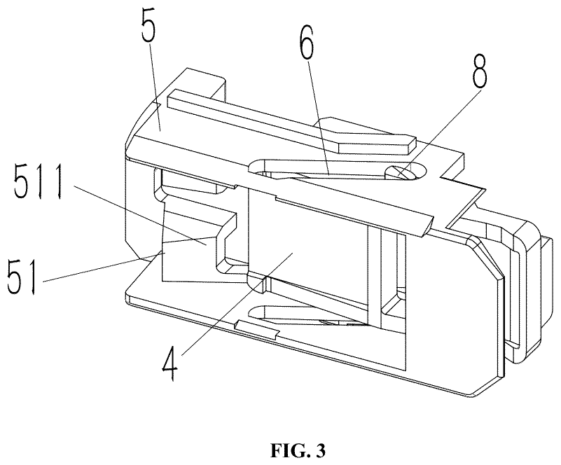

With reference to FIGS. 3-7, a front side of the clamping block 51 is provided with a gear upper slope 511. The gear upper slope 511 blocks a rear side end of the moving plate 4. A middle of the clamping block 51 is provided with a notch 512 directly in communication with a lower portion, and a front side of the clamping block 51 of the mounting frame 5 is provided with an abdication groove 513. The notch 512 in the middle of the clamping block 51 is in communication with the abdication groove 513, and a conductive plug end is provided below the abdication groove 513. Two sides of the abdication groove 513 are provided with gear side slopes 514. The gear side slopes 514 block the rear side end of the moving plate 4. In the example, the moving plate 4 is constrained by cooperation of the sliding blocks 8 and the oblique sliding grooves 6, and is further protected by the gear upper slope 511 on the front side of the clamping block 51 and the gear side slopes 514 on two sides of an abdication groove 513 such that the situation that the moving plate 4 overturns in a process of vertical translation, which is not conducive to translation can be prevented, and further, the translation after the socket is plugged is smoother.

With reference to FIGS. 2-7, upper sides of the sliding blocks 8 are provided with sliding block planes 81, and upper ends of the oblique sliding grooves 6 are provided with upper planes 61 horizontally distributed. The structure makes the planes on the upper sides of the sliding blocks 8 to be attached and positioned to the upper planes of the oblique sliding grooves 6 after the moving plate 4 elastically returns and moves upwards, and a moving plate 4 body is transversely and horizontally distributed. Arc surfaces are formed outside the sliding block 8 planes, and lower ends of the oblique sliding grooves 6 are provided with sliding groove arc bottom surfaces 62 matching the arc surfaces of the sliding blocks such that the bottom can be quickly found after the moving plate 4 moves downwards to the bottom.

With reference to FIGS. 3, 4 and 7, a middle stop block 43 is arranged in a middle of the clamping groove 42, and when an upper end of the clamping block 51 is clamped into the clamping groove 42, the middle stop block 43 is embedded into the notch 512.

With reference to FIGS. 1, 9 and 10, in order to avoid electric shock due to plugging of a needle-like conductor, a blocking sheet 10 is fixedly arranged in the bottom shell 1, a plug sheet in the socket forms a conductive plug end, the blocking sheet 10 extends into the mounting frame 5 and is located above the conductive plug end at the jack on a front side, the blocking sheet 10 shields part of a front side of the conductive plug end, and the plug rod of the socket enters the conductive plug end from a rear side of the blocking sheet 10 when plugged. The function of the blocking sheet 10 lies in that when the single rod is plugged into the jack on the front side, since the moving plate basically covers an upper portion of the conductive plug end, the moving plate can block the rod member which has a diameter usually close to or slightly less than a diameter of the plug rod. However, there is a possibility that there is an extremely small gap between the front end of the moving plate and the mounting frame. If the single rod is an extremely small needle body, when the needle body is obliquely plugged forwards into the jack 3 on the front side, the needle body may pass through the gap to make contact with the conductive plug end, resulting in the risk of electric shock. However, when the blocking sheet 10 is used for blocking part of the front side of the conductive plug end, the gap can be blocked exactly, and the risk can be eliminated.

With reference to FIGS. 2, 3, 9 and 10-12, at two side ends of the moving plate 4 in the present disclosure, the sliding blocks 8 are plugged into the oblique sliding grooves 6 of the two side plates of the mounting frame 5 to achieve sliding fit, the two sliding blocks 8 are located in the middle of the moving plate 4, the two plug rods of the socket simultaneously push against the moving plate 4 when plugged, and pushed positions are located at two sides of a connecting line of the two sliding blocks 8 separately; and in this case, the two sides of the movable plate are uniformly stressed and pressed down, and the sliding blocks 8 are constrained by the oblique sliding grooves 6 to obliquely slide downwards in a pressing process, such that the through holes 7 and a rear space of the moving plate 4 are aligned with the jacks 3 above, and the plug is plugged into the channel to achieve conduction. When the single rod member is plugged into the jack 3 on a front side separately, the rear end of the moving plate 4 is titled upwards, such that the clamping bumps 41 on the moving plate 4 clamp the bump clamping grooves 21 on the lower side of the surface cover 2. When the rod member is plugged into the jack 3 on a rear side separately, the rear end of the moving plate 4 swings downwards, such that the clamping groove 42 on the moving plate 4 is clamped to the clamping block 51 for matching. In two cases, the moving plate 4 can be prevented from moving downwards, such that a blocking state for the rod member can be maintained, and the situation that the conductive rod member of the plug rod is abdicated to the position of the channel and is plugged for accidental conduction due to sliding of the moving plate is avoided. Because only one moving plate 4 is used, the structure is relatively simple, and mounting is more convenient. Moreover, movement of the moving plate is constrained by cooperation of the sliding blocks and the oblique sliding grooves, and a whole movement process is more efficient and stable.

The above examples are merely intended for describing the technical solutions of the present disclosure rather than limiting the present disclosure. Although the present disclosure is described in detail with reference to the above examples, those of ordinary skill in the art should understand that they can still make modifications to the technical solutions described in the above examples or equivalent substitutions to some or all of the technical features of the technical solutions. These modifications or substitutions do not enable the corresponding technical solutions to depart from the scope of the technical solutions of the examples of the present disclosure in essence.

What it claimed is:

1. An anti-misplug safety socket, comprising a bottom shell and a surface cover, wherein the surface cover is provided with at least two jacks, and the jacks are used for plugging plug rods to achieve conductive connection; the bottom shell is internally provided with a mounting frame for mounting a moving plate, two side plates of the mounting frame are provided with oblique sliding grooves obliquely distributed, the moving plate is arranged below the jacks, the moving plate is provided with at least one through hole through which the plug rod passes, the moving plate is provided with an elastic reset mechanism, the elastic reset mechanism pushes the moving plate to be in an initial position, the moving plate shields the two jacks in an initial position state, two sides of the moving plate are provided with sliding blocks, the sliding blocks are plugged into the oblique sliding grooves, the sliding blocks are located at top ends of the oblique sliding grooves in an initial position state, the moving plate is provided with a blocking mechanism, and when a single rod member is plugged into the jacks to push the moving plate, the pushed moving plate swings, such that the blocking mechanism achieves buckling, and the moving plate is prevented from moving by means of buckling; and the two plug rods of a plug synchronously push the moving plate when being simultaneously plugged into the two jacks, positions of the plug rods pushing against the moving plate are located at two sides of a connecting line of the two sliding blocks separately, the moving plate translates downwards along the oblique sliding grooves by taking the sliding blocks on two sides as fulcrums, and a channel for plugging is abdicated during translation of the moving plate, such that the plug continues to be plugged into the socket to achieve conductive plugging.

2. The anti-misplug safety socket according to claim 1, wherein the blocking mechanism comprises clamping bumps arranged at two corners of an upper side of a rear end of the moving plate and a clamping groove provided at a lower side of a rear end of the moving plate, and further comprises bump clamping grooves provided at a lower side of the surface cover corresponding to the clamping bumps and a clamping block arranged on the mounting frame corresponding to the clamping groove and matching the clamping groove, wherein an upper end of the clamping block is provided with a clamping end capable of being clamped into the clamping groove.

3. The anti-misplug safety socket according to claim 1, wherein a front side of the clamping block is provided with a gear upper slope.

4. The anti-misplug safety socket according to claim 3, wherein a middle of the clamping block is provided with a notch directly in communication with a lower portion, and a front side of the clamping block of the mounting frame is provided with an abdication groove.

5. The anti-misplug safety socket according to claim 4, wherein two sides of the abdication groove are provided with gear side slopes.

6. The anti-misplug safety socket according to claim 4, wherein the notch in the middle of the clamping block is in communication with the abdication groove.

7. The anti-misplug safety socket according to claim 1, wherein upper sides of the sliding blocks are provided with sliding block planes, upper ends of the oblique sliding grooves are provided with upper planes horizontally distributed, arc surfaces are formed outside the sliding block planes, lower ends of the oblique sliding grooves are provided with sliding groove arc bottom surfaces matching the arc surfaces of the sliding blocks, the planes on the upper sides of the sliding blocks are attached and positioned to the upper planes of the oblique sliding grooves after the moving plate elastically returns and moves upwards, and a moving plate body is transversely and horizontally distributed.

8. The anti-misplug safety socket according to claim 4, wherein a middle stop block is arranged in a middle of the clamping groove, and when an upper end of the clamping block is clamped into the clamping groove, the middle stop block is embedded into the notch.

9. The anti-misplug safety socket according to claim 1, wherein a blocking sheet is fixedly arranged in the bottom shell, a plug sheet in the socket forms a conductive plug end, the blocking sheet extends above the conductive plug end at the jack on a front side, the blocking sheet shields part of a front side of the conductive plug end, and the plug rod of the socket enters the conductive plug end from a rear side of the blocking sheet when plugged.

10. The anti-misplug safety socket according to claim 1, wherein two sets of moving plates and mounting frames are arranged in the socket, a set of jacks on the surface cover is correspondingly arranged above each set of moving plates and mounting frames, and the elastic reset mechanism comprises a reed arranged on a frame in the bottom shell, wherein two ends of the reed are tilted to support front end plates of the moving plates on two sides respectively.
